(19) United States
(12) Patent Application Publication
(10) Pub. No.: US 2026/0105497 A1
(43) Pub. Date: Apr. 16, 2026

(54) METHOD AND SYSTEM FOR ASSOCIATING USERS ACROSS WEB BASED PLATFORMS

(71) Applicant: AUK Commerce Tech Private Limited, New Delhi (IN)

(72) Inventor: Shamail Tayyab, Delhi (IN)

(73) Assignee: AUK Commerce Tech Private Limited, New Delhi (IN)

(21) Appl. No.: 19/023,790

(22) Filed: Jan. 16, 2025

(30) Foreign Application Priority Data
Oct. 16, 2024 (IN) 202411078715

(51) Int. Cl. G06Q 30/0241; G06N 20/00

(52) U.S. Cl. CPC G06Q 30/0277; G06N 20/00

(57) ABSTRACT

The present disclosure provides a system for tracking and associating a user across a plurality of web-based platforms. The system includes a main server and a hardware signal generator module. The system performs a set of operations that include receiving a request from a client device, collecting a first data associated with the client device, computing a second data, capturing a third data, gathering a fourth data, training the system using an artificial intelligence engine based on the first data, the second data, the third data and the fourth data, assigning a unique ID to the user of the plurality of users, associating the user of the plurality of users, creating a shared database of the associated users across the plurality of web-based platforms and generating alerts for each user association across the plurality of web-based platforms.

### TECHNICAL FIELD

The present invention relates to the field of tracking technologies, and in particular, relates to a method and a system for tracking and associating users across web-based platforms.

### INTRODUCTION

Advertising technologies have witnessed exponential growth and evolution in recent years, propelled by advancements in digitalization and the proliferation of online platforms. The landscape of advertising has been transformed from traditional display ads to highly targeted programmatic advertising and sophisticated data-driven approaches. With the ever-increasing digital consumption and data, advertisers and brands have unprecedented opportunities to engage with consumers across various digital touchpoints. Nowadays, a user has innumerable options of devices for communication as well as searching for the information on the web. The user can communicate and/or browse the information by using mobile phones, laptops, personal computers, tablets, personal digital assistants, and the like. There are various techniques to track the users. Each of the techniques have their respective set of advantages and disadvantages.

### SUMMARY

The present disclosure provides a system for tracking and associating a user across a plurality of web-based platforms. The system includes a main server and a hardware signal generator module. The main server is communicatively coupled with one or more hardware components associated with a client device of the user. The main server includes one or more processors and a non-transitory memory in communication with the one or more processors. The non-transitory memory stores instructions that are executable by the one or more processors to cause the main server to perform a set of operations. The set of operations include receiving a request from the client device for accessing at least a first web-based platform and a second web-based platform of the plurality of web-based platforms in real time. The user of a plurality of users accesses the at least first web-based platform and the second web-based platform on a web browser installed on the client device. In addition, the set of operations include collecting a first data associated with the client device in real time. The first data includes an IP address assigned to the client device. Moreover, the set of operations include computing a second data associated with the web browser installed on the client device. The second data includes a fingerprint information associated with the web browser. Further, the set of operations include capturing a third data from the one or more hardware components of the client device. The third data includes historical and real time information associated with change in behaviour of the one or more hardware components when the user visits the plurality of web-based platforms. Furthermore, the set of operations include gathering a fourth data associated with a usage data of the client device in relation to the access of the plurality of web-based platforms. The fourth data includes a real time and historical information of the usage data. Moreover, the set of operations include training the system using an artificial intelligence engine based on the first data, the second data, the third data and the fourth data for predicting at least one of a behaviour of use of the web browser on the client device and calculating a score for determining that the user accessing the at least first web-based platform and the second web-based platform is same. The score is greater than a threshold score value for the system to determine that the user is same. In addition, the set of operations include assigning a unique ID to the user of the plurality of users based on a combination of the IP address associated with the client device and the fingerprint information associated with the web browser. Further, the set of operations include associating the user of the plurality of users across the at least first web-based platform and the second web-based platform based on a combination of the unique ID, IP address, the fingerprint information associated with the web browser and the prediction. Further, the set of operations include creating a shared database of the associated users across the plurality of web-based platforms. The hardware signal generator module is communicatively coupled with the main server. The hardware signal generator receives, from the main server, information associated with at least one user association across the plurality of web-based platforms.

In an embodiment of the present disclosure, the set of parameters used for computing the fingerprint of the web browser comprises at least a list of installed fonts, screen resolution, browser agent string, JavaScript rendering ability of the browser, local storage present for the browser or not and GPU present or not.

In an embodiment of the present disclosure, the third data includes a current location, an ambient light parameter, communication network availability corresponding to the current location, proximity of the user with the client device, user movement data and a change in a location of the client device.

In an embodiment of the present disclosure, the browser data includes current browser version, last browser version updated date and time, browser version outdated or not, use of more than one browser in a corresponding location, number of browsers installed and information related to use of browsers on multiple devices for a single user in an event of change of device.

In an embodiment of the present disclosure, a unique ID is assigned to the user on each instance of visit on a web-based platform if a combination of the IP address and the fingerprint does not exist in the shared database.

In an embodiment of the present disclosure, a previously assigned ID is assigned on each instance of visit on a web-based platform if a combination of the IP address and the fingerprint exists in the shared database.

In an embodiment of the present disclosure, the training of the artificial intelligence engine is done by providing the first data, the second data, the third data and the fourth data to form the training dataset, by extracting one or more relevant features from the training dataset and inputting the training dataset to train at least one artificial intelligence-based algorithm of a plurality of artificial intelligence-based algorithms. The at least one artificial intelligence-based algorithm is trained to identify patterns in behaviour of use of the browser and IP address changes and predict a future behaviour of use.

In an embodiment of the present disclosure, using the artificial intelligence engine enables prediction of whether a user on a first web-based platform is same as a user on a second web-based platform.

In an embodiment of the present disclosure, using the artificial intelligence engine enables prediction of a change in the fingerprint information based on an analysis of the browser data and correlation with the third data and the fourth data. The prediction information is utilized to update the shared database automatically with the change in the fingerprint information.

In an embodiment of the present disclosure, creating one or more clusters of the plurality of users based on the associations of the plurality of users across the plurality of web-based platforms using the artificial intelligence engine. The one or more clusters are created based on at least one or a combination of similarity in type of web-based platforms accessed by the plurality of users, similarity in a device profile of the plurality of users, age group, a similarity in behaviour of the usage data related to time of access and a threshold distance between the plurality of users based on a location of access.

### BRIEF DESCRIPTION OF THE DRAWINGS

Having thus described the invention in general terms, references will now be made to the accompanying figures, wherein:

FIG. 1 illustrates an exemplary scenario of a plurality of users accessing a plurality of web-based platforms, in accordance with an embodiment of the present disclosure;

FIG. 2 illustrates an interactive computing environment depicting a system for tracking and associating a user of the plurality of users across the plurality of web-based platforms, in accordance with various embodiments of the present disclosure; and

FIG. 3 illustrates a block diagram of a computing device, in accordance with various embodiments of the present invention.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced items.

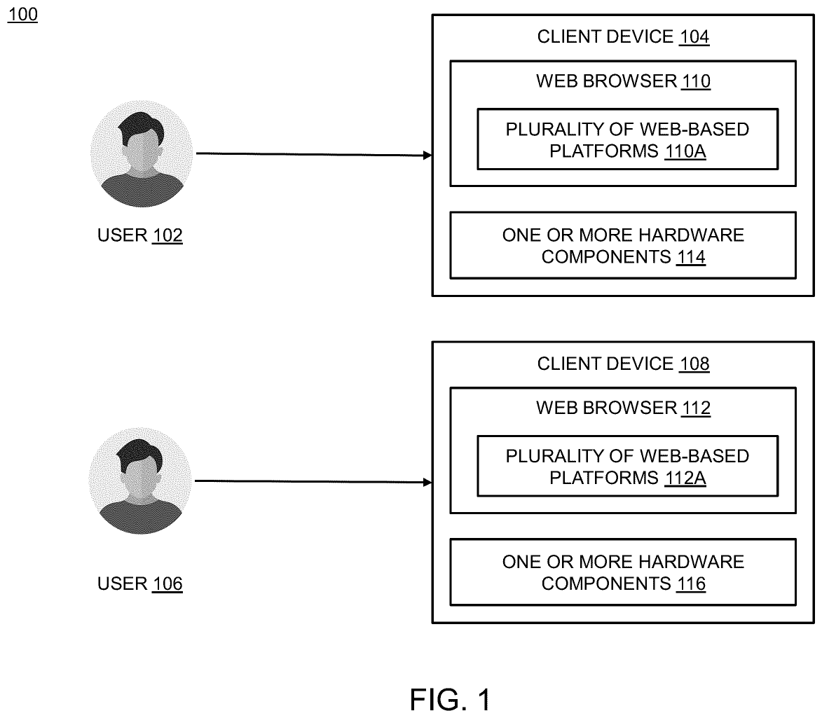

FIG. 1 illustrates an exemplary scenario 100 of a plurality of users accessing a plurality of web-based platforms, in accordance with an embodiment of the present disclosure. The exemplary scenario 100 depicts the plurality of users accessing the plurality of web-based platforms on corresponding communication devices. The exemplary scenario 100 includes a user 102, a client device 104, a user 106 and a client device 108. The user 102 is associated with the client device 104. The user 106 is associated with the client device 108.

The user 102 and the user 106 may be any individual or an entity who access online content on the client device 104 and the client device 108 respectively. Examples of the users 102 and 106 include working professionals, casual users, students and academics, tech enthusiasts, gamers, shoppers and consumers, travellers and explorers, social influencers, and the like. The client device 104 and the client device 108 correspond to electronic devices equipped with networking capabilities and user interface functionalities designed to connect to internet and retrieve web-based information. The client devices 104 and 108 may be a wired device or a wireless device. Examples of the client device includes smartphones, tablets, laptops, desktop computers, personal digital assistants and wearable gadgets. In addition, the client device 104 and the client device 108 utilize internet protocols and communication technologies to establish connections with web servers and request web pages and digital content.

The user 102 and the user 106 exemplify individuals accessing web-based platforms through their communication devices. Referring to the FIG. 1, the user 102 accesses a web browser 110 installed on the client device 104. Similarly, the user 104 accesses a web browser 112 installed on the client device 108. In general, a web browser is a software application or program, that provides a user interface tool for accessing and navigating information on the World Wide Web. In addition, the web browser facilitates interaction with web pages, websites, and web-based content by interpreting and rendering Hypertext Markup Language (HTML), Cascading Style Sheets (CSS), JavaScript, and other web technologies. The web browser acts as a client application that retrieves and displays web content from remote servers, allowing users to browse, search, interact, and consume online resources.

Examples of the web browsers 110-112 include but may not be limited to Google Chrome, Mozilla Firefox, Safari, Microsoft Edge, and Opera. The user 102 accesses a plurality of web-based platforms 110a on the corresponding web browser 110 on the client device 104. The user 106 accesses a plurality of web-based platforms 112a on the corresponding web browser 112 on the client device 108. The users 102 and 104 interact with the corresponding web-based platforms. Each user's interaction encompasses a range of activities, including but not limited to browsing websites, consuming multimedia content, engaging with social media platforms, conducting e-commerce transactions, and accessing web-based applications for various purposes.

The users 102 and 104 seamlessly navigate between the corresponding plurality of web-based platforms 110a and 112a. The users 102-104 may engage in a plethora of activities while accessing the plurality of web-based platforms 110a, 112a. The activities may include search and discovery on popular search engines, browsing and navigating on different websites, consuming content such as blogs, posts, videos, podcasts, and the like. In addition, the activities may include e-commerce transactions, communicating with others over social media, entertainment and gaming, learning and education, and the like.

In an exemplary scenario, the users 102-104 may access the web-based platforms from different geographical locations. Examples of the geographical locations include home, workplace, public spaces, or while traveling. The users 102-104 may experience difference in factors at multiple locations such as internet speed, network availability, and content localization. The users 102-104 may encounter varying network conditions including stable Wi-Fi connections, cellular data networks with different speeds and reliability, or intermittent connectivity in remote areas or during network congestion.

In another exemplary scenario, the users 102-104 may toggle between different web browsers for accessing the web-based platforms. The users 102-104 have a choice between different web browsers but may end up using one browser on a consistent basis. The choice or a change in browser may be affected by a particular geographical location or compatibility of some web-based platforms or applications with certain browsers. In such an event, the users 102-104 may need to switch to a different browser or update their current browser to access certain content.

In yet another exemplary scenario, the users 102-104 may be moving from one place to another continuously leading to transitions between Wi-Fi and cellular networks. In such an event, the users 102-104 may choose between different browsers or may need to update the browsers. In yet another exemplary scenario, the users 102-104 may experience problems in accessing the web browsers due to weather conditions or hardware issues with the communication devices.

In yet another exemplary scenario, the users 102-104 may experience compatibility issues between certain web browsers and corresponding communication devices. This may be due to factors such as screen size, screen resolution, and other capabilities. In yet another exemplary scenario, the users 102-104 may have different individual accessibility needs for accessing and browsing content on different web-based platforms. Examples include requirement of screen readers, keyboard navigation, high contrast modes, screen zoom percentage, and the like. In various implementations, the users 102-104 may experience the above-mentioned scenarios in multiple combinations. The client device 104 includes one or more hardware components 114. The client device 108 includes one or more hardware components 116. The one or more hardware components 114-116 correspond to several hardware sensors installed in the corresponding client devices 104 and 108. Each of the one or more hardware components 114-116 is configured to perform distinct functions to enhance user interaction and device performance. The one or more hardware components 114-116 include but may not be limited to an ambient light sensor, one or more location sensor, one or more motion sensor and proximity sensor.

The one or more motion sensor is used for determining all movements of a device, like tilt, shake, rotation, or swing. The one or more motion sensor includes accelerometer, gyroscope and barometer. The accelerometer measures or senses changes in orientation of a device. The accelerometer detects and measures the device's acceleration forces, enabling functionalities such as screen rotation, gesture detection, and motion-based control. The gyroscope estimating the device's position by tracking its movements and orientation changes. The gyroscope helps the accelerometer out with understanding which way the device is orientated. The proximity sensor is used to detect a closeness between a user and the device using infrared light. The proximity sensor detects nearby objects without physical contact, typically used to disable the touch screen during phone calls when the device is near the user's ear.

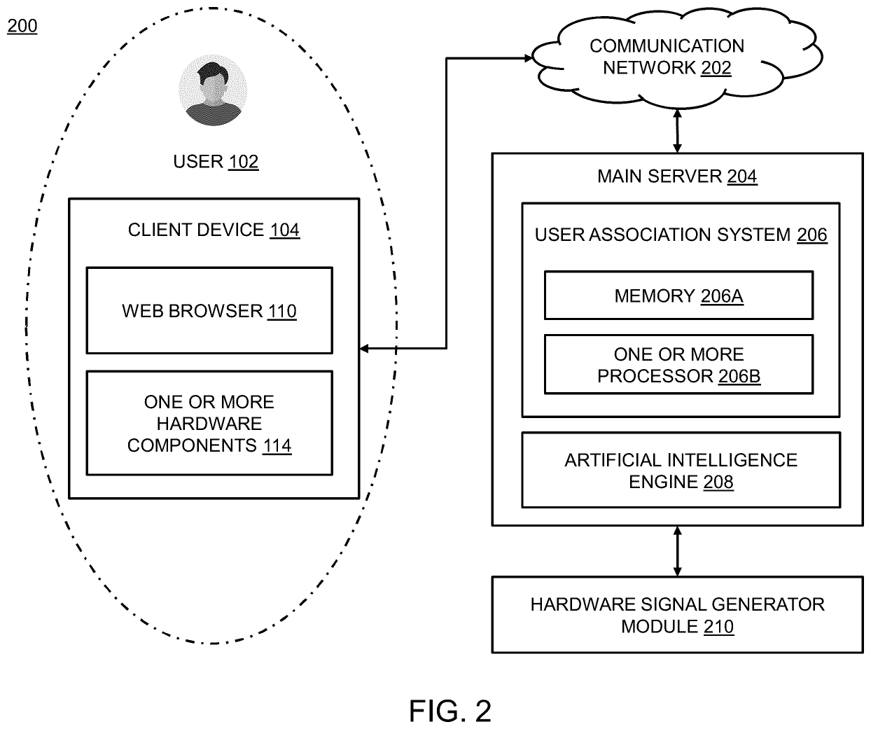

The present disclosure makes use of data from the above-mentioned sensors (explained below in the detailed description of FIG. 2). It may be noted that the present disclosure may use data from more sensors installed in the client device other than the ones mentioned above.

FIG. 2 illustrates an interactive computing environment depicting a system 200 for tracking and associating the user of a plurality of users across the plurality of web-based platforms, in accordance with various embodiments of the present disclosure. FIG. 2 exemplifies a significance of cross-platform user association in facilitating targeted advertising, personalized content delivery, and comprehensive analytics for advertisers and platform operators. The system 200 tracks and associates'users across web-based platforms in an efficient manner. The system 200 may share the information related to the associated users with advertisers who can run optimized advertisement campaigns. The system 200 uses artificial intelligence technologies to track and associate the users with high accuracy and reduce false matches.

The system 200 includes the client device 104, a communication network 202, a main server 204 and a hardware signal generator module 210. The main server 204 includes a user association system 206 and an artificial intelligence engine 208. The user association system 206 includes a memory 206a and one or more processor 206b. The above-mentioned system elements work in conjunction for enabling tracking and association of the users across the plurality of web-based platforms. It may be noted that to explain the functionality of the system 200 in the FIG. 2, reference will be made to elements of the FIG. 1. The present disclosure related to tracking and associating of the users is explained using one user (the user 102) and one device (the client device 104); however, it may be obvious to a person skilled in the art that there may be a greater number of users being tracked and associated and their corresponding devices.

The system 200 tracks and associates the user 102 across the plurality of web-based platforms 110a. The user 102 accesses the plurality of web-based platforms 110a through the web browser 110 installed on the client device 104 (as explained above in the description of the FIG. 1). The user association system 206 communicates with the main server 204. The main server 204 is communicatively coupled with the one or more hardware components 114 embedded in the client device 104. The memory 206a is in communication with the one or more processor 206b. The memory 206a stores instructions that are executable by the one or more processor 206b to cause the main server 204 to perform a set of operations. The main server 204 performs the set of operations.

The main server 204 receives a request from the client device 104 for accessing at least a first web-based platform and a second web-based platform of the plurality of web-based platforms 110a in real time. The user 102 of a plurality of users accesses the at least first web-based platform and the second web-based platform on the web browser 110 installed on the client device 104. The main server 204 receives an HTTP based request in real time as soon as the user 102 loads a webpage of the at least first web-based platform and the second web-based platform on the web browser 110. The main server 204 receives the HTTP request from the web browser 110 in real time. In an embodiment of the present disclosure, the main server 204 is a host server for the plurality of web-based platforms 110a. In an embodiment of the present disclosure, the host server may be a different server other than the main server 204.

The main server 204 processes the HTTP request and sends an HTTP response. The web browser 110 receives the HTTP response in form of HTML content with external JavaScript references. The web browser 110 parses the HTML content and sends additional HTTP GET request to fetch or download the referenced JavaScript files. The main server 204 responds with the JavaScript file content. A JavaScript engine of the web browser 110 executes the JavaScript file content once the JavaScript files are downloaded. The JavaScript engine is linked to the main server 204 which executes various operations for tracking and associating the users across the plurality of web-based platforms.

In an embodiment of the present disclosure, the JavaScript engine collects various types of data related to the web browser 110, the client device 104 and the one or more hardware components 114 in real time. Accordingly, the JavaScript engine transmits the collected data to the main server 204 for processing.

The main server 204 collects a first data associated with the client device in real time. The first data includes an IP address assigned to the client device 104. The IP address refers to a unique numerical label assigned to each device connected to a computer network that uses an Internet Protocol for communication. The IP address serves as an identifier for the device within the network, allowing it to send and receive data packets to and from other devices. The IP address keeps changing each time the client device 104 is connected to a different internet connection.

The main server 204 computes a second data associated with the web browser 110 installed on the client device 104. The second data includes a fingerprint information associated with the web browser 110. The fingerprint information corresponds to a unique hash value of a set of parameters associated with the web browser 110. In an embodiment of the present disclosure, wherein the set of parameters used for computing the fingerprint information of the web browser 110 includes at least a list of installed fonts and screen resolution. In addition, the set of parameters include a browser agent string, JavaScript rendering ability of the browser, local storage present for the browser or not and GPU present or not. In an embodiment of the present disclosure, there may be a greater number of parameters used for computing the fingerprint. In an embodiment of the present disclosure, the unique hash value is a 48-character string value. In an example implementation, the unique hash value may be 1e2b. In an embodiment of the present disclosure, the fingerprint information or the unique hash value remains same as long as a version of the web browser 110 is not updated.

The main server 204 captures a third data from the one or more hardware components 114 of the client device 104. The third data includes historical and real time information associated with a change in behaviour of the one or more hardware components 114 when the user 102 visits the plurality of web-based platforms 110a. The change in behaviour corresponds to a change in data corresponding to each of the one or more hardware components 114. The change in behaviour is determined in various exemplary scenarios mentioned above in the FIG. 1.

The one or more hardware components 114 includes at least the ambient light sensor, the one or more location sensor, the one or more motion sensor and the proximity sensor. The one or more hardware components 114 have been explained in detail in the description of the FIG. 1. In an embodiment of the present disclosure, the third data includes a current location, an ambient light parameter, communication network availability corresponding to the current location, proximity of the user 102 with the client device 104, user movement data and a change in a location of the client device 104. It may be noted that there may be greater number of parameters in the third data from the ones mentioned here.

In an example, there may be sudden changes in data from motion sensors and location sensors when a user may be moving consistently which may show that the user may be in a different location. The location may be a high-altitude location. In another example, there may be sudden changes in data from the ambient light sensor when a battery level of a device is low or set on automatic adjustment by the user. In yet another example, the data from the proximity sensor may suggest that the user is busy on a phone call, or any object is in proximity to the device.

The main server 204 gathers a fourth data associated with the user. The fourth data includes a usage data of the client device 104 by the user 102 in relation to the access of the plurality of web-based platforms 110a and a device setting behaviour of the user 102. The usage data corresponds to a real time and historical information of the usage data associated with the web browser 110. The usage data corresponds to a behaviour of use of the web browser 110 by the user 102 in multiple exemplary scenarios explained in the FIG. 1. The device setting behaviour corresponds to multiple settings corresponding to multiple features in a device set by the user as per convenience. The device setting behaviour corresponds to at least one of contrast value set by the user, screen zoom percentage, reading behaviour, typing speed and typing style.

The memory 206a stores the first data, the second data, the third data and the fourth data. The main server 204 includes the artificial intelligence engine 206. The artificial intelligence engine 206 fetches the first data, the second data, the third data and the fourth data from the memory 206a. The artificial intelligence engine 206 trains the system 200 using the first data, the second data, the third data and the fourth data. The system 200 is trained for predicting at least one of a behaviour of use of the web browser 110 on the client device 104. In addition, the system 200 is trained for calculating a score for determining that the user 102 accessing the at least first web-based platform and the second web-based platform is same. The system is trained with a training dataset consisting of the first data, the second data, the third data and the fourth data.

In an embodiment of the present disclosure, the training of the system 200 is done by performing a series of steps. The series of steps include a first step of providing the first data, the second data, the third data and the fourth data to form the training dataset. The series of steps include a second step of extracting one or more relevant features from the training dataset. Examples of the one or more features may be frequency of IP address changes, frequency of movement of the user, variability in change in browser fingerprint, and the like. The series of steps include a third step of inputting the training dataset to at least one artificial intelligence-based algorithm of a plurality of artificial intelligence-based algorithms. The at least one artificial intelligence-based algorithm identifies patterns in behaviour of use of the browser and IP address changes and predict a future behaviour of use.

In an embodiment of the present disclosure, the plurality of artificial intelligence-based algorithms includes supervised learning algorithms, unsupervised learning algorithms and deep neural networks. The system 200 may make use a combination of at least two types of algorithms of the plurality of artificial intelligence-based algorithms. In an example implementation, the supervised learning algorithms like logistic regression and decision trees can be used for identifying patterns in user behaviour across different platforms based on the analysis of the first data and the second data. Additionally, a support vector machine algorithm can be used to distinguishing between different browsers based on the fingerprint information.

In another example implementation, the unsupervised learning algorithms like clustering algorithms can be used. Examples include k-means for grouping or clustering similar users based on similarity in behaviour and usage patterns based on the provided data. The clustering helps in predicting whether the same user is accessing different platforms even if the fingerprint or IP address changes.

In yet another example implementation, the system 200 can use Convolutional Neural Networks (CNN) and Recurrent Neural Networks (RNNs). The Convolutional Neural Networks (CNNs) can be applied to analyze and recognize patterns in user interaction data such as typing speed, screen zoom levels, and ambient light changes that correlate with user identity. The Recurrent Neural Networks (RNNs) are used to handle sequential data, such as the historical behavior of users. The RNNs assist in predicting future behavior based on past interactions, enabling the 200 system to make more accurate predictions about user actions.

In various implementations, the system 200 utilizes the combination of multiple artificial intelligence-based algorithms. Each of the plurality of artificial intelligence-based algorithms provides predictions. The prediction is done based on one or more real time inputs from the one or more hardware components 114 and the real time fourth data. The system 200 using the artificial intelligence-based engine is configured to analyse the first data, the second data, the third data and the fourth data. The system is further configured to correlate one or more changes in the first data and the second data based on the historical and real time information from the one or more hardware components 114 and the historical and real time information from the fourth data. Accordingly, the system 200 predicts changes in the first data and the second data based on the one or more real time inputs from the one or more hardware components 114, the real time fourth data and a browser data.

In an embodiment of the present disclosure, the browser data includes current browser version, last browser version updated date and time, browser version outdated or not, use of more than one browser in a corresponding location, number of browsers installed and information related to use of browsers on multiple devices for a single user in an event of change of device.

In an embodiment of the present disclosure, the system 200 uses the artificial intelligence engine 208 to predict whether a user on a first web-based platform is same as a user on a second web-based platform. In an embodiment of the present disclosure, the system 200 combines the predictions from various artificial intelligence models to calculate the score for determining the user identity. The score is greater than a threshold score value for the system 200 to determine that the user 102 is same.

The main server 204 assigns a unique ID to the user 102 of the plurality of users based on a combination of the IP address associated with the client device 104 and the fingerprint information associated with the web browser 110. The unique ID is assigned at each instance of the user visit on a web-based platform. In an embodiment of the present disclosure, the unique ID may be a numerical ID, an alphanumerical ID, and the like.

The main server 204 associates the user 102 of the plurality of users across the at least first web-based platform and the second web-based platform based on a combination of the unique ID, IP address, the fingerprint information associated with the web browser, the prediction, the score and a correlation of the real time third data from at least one hardware component of the one or more hardware components 114. The association of the user 102 of the plurality of users is done using the artificial intelligence engine.

The main server 204 creates a shared database of the associated users across the plurality of web-based platforms 110a-112a. The shared database stores information of each instance of a user visit on each web-based platform of the plurality of web-based platforms. The system 200 continuously checks for the unique ID and corresponding fingerprint and IP address in the shared database on each instance of user visit on a web-based platform. The system 200 updates the shared database using the artificial intelligence engine 208 dynamically.

In an embodiment of the present disclosure, the system 200 assigns a unique ID to the user on each instance of visit on a web-based platform if a combination of the IP address and the fingerprint does not exist in the shared database. In an embodiment of the present disclosure, the system 200 assigns a previously assigned ID on each instance of visit on a web-based platform if a combination of the IP address and the fingerprint exists in the shared database.

In an embodiment of the present disclosure, the artificial intelligence engine 208 predicts a change in the fingerprint information based on an analysis of the browser data and correlation with the third data and the fourth data. The prediction information is utilized by the system 200 to update the shared database automatically with the change in the fingerprint information.

In an embodiment of the present disclosure, the system creates one or more clusters of the plurality of users based on the associations of the plurality of users across the plurality of web-based platforms. The one or more clusters are created based on at least one or a combination of similarity in type of web-based platforms accessed by the plurality of users, similarity in a device profile of the plurality of users, age group, a similarity in behaviour of the usage data related to time of access and a threshold distance between the plurality of users based on a location of access.

The system 200 includes the hardware signal generator module 210. The hardware signal generator module 210 is communicatively coupled with the main server 204. The hardware signal generator module 210 is configured to receive information associated with at least one user association across the plurality of web-based platforms. The hardware signal generator module 210 receives the information from the main server 204. Further, the hardware signal generator module 210 generates one or more signals pertaining to one or more alerts corresponding to each user associated across the plurality of web-based platforms. The hardware signal generator module 210 sends information in form of the one or more signals to one or more stakeholders for each new association for each corresponding user for retargeting. The one or more stakeholders include advertisers, ad agencies, publishers, and the like.

The system 200 enables the tracking of the user across the plurality of web-based platforms based on a unique combination of the IP address and the fingerprint information for recognizing the user across the plurality of web-based platforms. The system 200 offers several advantages such as enhanced accuracy by combining traditional identifiers with real-time behavioral data and AI analysis. The system achieves a more accurate picture of user identity across platforms. In addition, the system 200 enables creation of rich user profiles by gathering a wider range of data points, enabling the creation of more detailed user profiles for targeted advertising.

In various embodiments, the main server 204 performs a multitude of tasks, including but not limited to data storage, processing, and dissemination over a network. The main server 204 may comprise hardware components such as processors, memory modules, storage devices, and networking interfaces, as well as software components for managing and executing various functions. The main server 204 may further include features such as security protocols to ensure efficient and reliable operation. Additionally, the main server 204 may be scalable to accommodate varying workloads and may be configured for integration within distributed computing environments. Various aspects of the disclosure may be implemented using different architectures, protocols, and technologies, providing flexibility and adaptability to different usage scenarios.

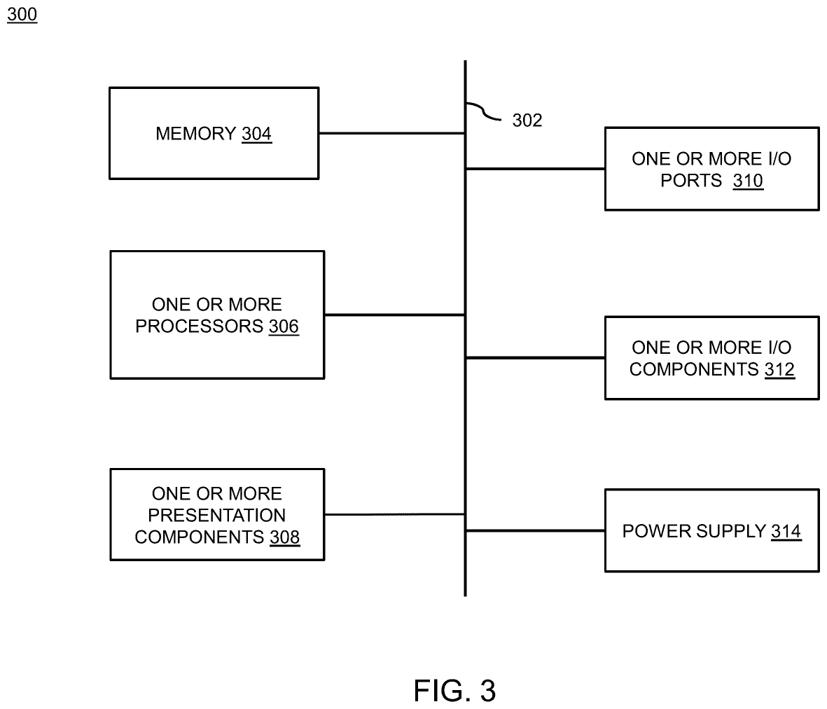

FIG. 3 illustrates a block diagram of a hardware framework of a computing device 300, in accordance with various embodiments of the present disclosure. The computing device 300 is in communication with the main server 204. The hardware framework of the computing device 300 includes a bus 302 that directly or indirectly couples the following devices: a memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an example of the computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device. ” The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The memory 304 includes computer-storage media in the form of volatile and/or nonvolatile memory. The memory 304 may be removable, non-removable, or a combination thereof.

The present invention has been described with reference to particular embodiments and examples. It is to be understood that these embodiments and examples are merely illustrative of the principles and applications of the present invention. It is, therefore, to be understood that the present invention is not limited to the above examples and embodiments.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described embodiments.

We claim:

1. A system for tracking and associating a user across a plurality of web-based platforms, the system comprising:
a main server communicatively coupled with one or more hardware components embedded in a client device of the user, the main server comprising:
one or more processor;
a non-transitory memory in communication with the one or more processor and storing instructions that are executable by the one or more processor to cause the main server to perform a set of operations, the set of operations comprising:
receiving a request from the client device for accessing at least a first web-based platform and a second web-based platform of the plurality of web-based platforms in real time, wherein the user of a plurality of users accesses the at least first web-based platform and the second web-based platform on a web browser installed on the client device;
collecting a first data associated with the client device in real time, wherein the first data comprises an IP address assigned to the client device;
computing a second data associated with the web browser installed on the client device, wherein the second data comprises a fingerprint information associated with the web browser, wherein the fingerprint information corresponds to a unique hash value of a set of parameters associated with the web browser;
capturing a third data from the one or more hardware components embedded in the client device, wherein the third data comprises historical and real time information associated with change in behaviour of the one or more hardware components when the user visits the plurality of web-based platforms, wherein the one or more hardware components comprises at least an ambient light sensor, one or more location sensor, one or more motion sensor and proximity sensor;
gathering a fourth data associated with the user, the fourth data comprising a usage data of the client device by the user in relation to the access of the plurality of web-based platforms and a device setting behaviour of the user, wherein the usage data corresponds to a real time and historical information of the usage data associated with the web browser and the device setting behaviour corresponds to at least one of contrast value set by the user, screen zoom percentage, reading behaviour, typing speed and typing style;
training, by an artificial intelligence engine, the system using the first data, the second data, the third data and the fourth data for predicting at least one of a behaviour of use of the web browser on the client device and calculating a score for determining that the user accessing the at least first web-based platform and the second web-based platform is same, wherein the score is greater than a threshold score value for the system to determine that the user is same, wherein the system is trained with a training dataset consisting of the first data, the second data, the third data and the fourth data, wherein the prediction is done based on one or more real time inputs from the one or more hardware components and the real time fourth data, wherein the system using the artificial intelligence engine is configured to:
analyse the first data, the second data, the third data and the fourth data;
correlate one or more changes in the first data and the second data based on the historical and real time information from the one or more hardware components and the historical and real time information from the fourth data;
predicting, using the artificial engine, changes in the first data and the second data based on the one or more real time inputs from the one or more hardware components, the real time fourth data and a browser data;
assigning a unique ID to the user of the plurality of users based on a combination of the IP address associated with the client device and the fingerprint information associated with the web browser, wherein the unique ID is assigned at each instance of a user visit on a web-based platform;
associating the user of the plurality of users across the at least first web-based platform and the second web-based platform based on a combination of the unique ID, the IP address, the fingerprint information associated with the web browser, the prediction, the score and a correlation of the real time third data from at least one hardware component of the one or more hardware components, wherein the associating the user of the plurality of users is done using the artificial intelligence engine;
creating a shared database of associated users across the plurality of web-based platforms, wherein the shared database stores information of each instance of a user visit on each web-based platform of the plurality of web-based platforms, wherein the system continuously checks for a unique ID and corresponding fingerprint and IP address in the shared database on each instance of a user visit on a web-based platform, wherein the system updates the shared database using the artificial intelligence engine dynamically; and
a hardware signal generator module communicatively coupled with the main server, the hardware signal generator module is configured for:
receiving, from the main server, information associated with at least one user association across the plurality of web-based platforms;
generating one or more signals pertaining to one or more alerts corresponding to each user associated across the plurality of web-based platforms, wherein the hardware signal generator module sends information in form of the one or more signals to one or more stakeholders for each new association for each corresponding user for retargeting, wherein the system enables the tracking of the user across the plurality of web-based platforms based on a unique combination of the IP address and the fingerprint information for recognizing the user across the plurality of web-based platforms.

2. The system as claimed in claim 1, wherein the set of parameters used for computing the fingerprint of the web browser comprises at least a list of installed fonts, screen resolution, browser agent string, JavaScript rendering ability of the browser, local storage present for the web browser or not and GPU present or not.

3. The system as claimed in claim 1, wherein the third data comprises a current location, an ambient light parameter, communication network availability corresponding to the current location, proximity of the user with the client device, user movement data and a change in a location of the client device.

4. The system as claimed in claim 1, wherein the browser data comprises current browser version, last browser version updated date and time, browser version outdated or not, use of more than one browser in a corresponding location, number of browsers installed and information related to use of browsers on multiple devices for a single user in an event of change of device.

5. The system as claimed in claim 1, wherein the system assigns a unique ID to a user on each instance of visit on a web-based platform if a combination of an IP address and a fingerprint does not exist in the shared database.

6. The system as claimed in claim 1, wherein the system assigns a previously assigned unique ID on each instance of visit of a user on a web-based platform if a combination of an IP address and a fingerprint exists in the shared database.

7. The system as claimed in claim 1, wherein the training of the system is done by:
providing the first data, the second data, the third data and the fourth data to form the training dataset;
extracting one or more relevant features from the training dataset; and
inputting the training dataset to train at least one artificial intelligence-based algorithm of a plurality of artificial intelligence-based algorithms, wherein the at least one artificial intelligence-based algorithm is trained to identify patterns in behaviour of use of the web browser and IP address changes and predict a future behaviour of use.

8. The system as claimed in claim 7, wherein the system using the artificial intelligence engine predicts whether a user on a first web-based platform is same as a user on a second web-based platform.

9. The system as claimed in claim 1, wherein the artificial intelligence engine predicts a change in the fingerprint information based on an analysis of the browser data and correlation with the third data and the fourth data, wherein the prediction information is utilized by the system to update the shared database automatically with the change in the fingerprint information.

10. The system as claimed in claim 1, further comprising creating, by the artificial intelligence engine, one or more clusters of the plurality of users based on associations of the plurality of users across the plurality of web-based platforms, wherein the one or more clusters are created based on at least one or a combination of similarity in type of web-based platforms accessed by the plurality of users, similarity in a device profile of the plurality of users, age group, a similarity in behaviour of the usage data related to time of access and a threshold distance between the plurality of users based on a location of access.
